(19) United States
(12) Patent Application Publication
(10) Pub. No.: US 2017/0181422 A1
(43) Pub. Date: Jun. 29, 2017

(54) GAME CALL DEVICE

(71) Applicant: Plano Molding Company, Plano, IL (US)

(72) Inventors: Dean Reagan, Bentonville, AR (US); Lyle Hedlund, Irving, TX (US)

(21) Appl. No.: 15/382,836

(22) Filed: Dec. 19, 2016

Related U.S. Application Data
(60) Provisional application No. 62/271,650, filed on Dec. 28, 2015.

(51) Int. Cl. A01M 31/00

(52) U.S. Cl. CPC A01M 31/004

(57) ABSTRACT

A game call device having a mouthpiece that includes a tone trough that carries and guides air moving through the mouthpiece, a reed aligned with and positioned proximate the tone trough, and a lip cushion that securely attaches to the bottom of the mouthpiece, wherein the lip cushion includes a base having a surface that contacts a user's teeth.

### CROSS REFERENCE TO PRIOR APPLICATION

This application claims priority to and the benefit thereof from U.S. Provisional Patent Application No. 62/271,650 filed on Dec. 28, 2015, titled “LIP CUSHION FOR OPEN REED GAME CALLS,” the entirety of which is hereby incorporated herein by reference.

### FIELD OF THE DISCLOSURE

The present disclosure relates generally to game call devices, and more particularly to a game call device that may be used to project sounds such as game calls or howling sounds over long distances or for extended periods of time.

### BACKGROUND OF THE DISCLOSURE

When calling animals such as game animals, the calling sequences may require long periods of calling, such as up to five minutes long, or longer in some instances, and up to four or five sequences per location. A caller typically blows extremely hard into a game call in order to project desired animal sounds over long distances. State of the art game calls are typically made of hard material. Thus, the calls can be difficult to grip with teeth, and, when the caller grips the hard material with his/her teeth and lips, he/she has to press so hard on the mouthpiece to maintain constant pressure to not only hold onto the call but to totally seal off any air leakage that reduces the overall performance and distance calling capabilities. This type of constant lip pressure can quickly cause lip and cheek fatigue.

### SUMMARY OF THE DISCLOSURE

According to an aspect of the disclosure, a game call device is disclosed that is easy to use and reduces lip and cheek fatigue, among other benefits. An embodiment of the game call device comprises a mouthpiece having a mouthpiece portion and an insertion portion, wherein the mouthpiece portion includes a tone trough that carries and guides air moving through the mouthpiece, a reed aligned with and positioned proximate the tone trough, a reed lock that secures an end portion of the reed to the mouthpiece, a lip cushion that securely attaches to the bottom portion of the mouthpiece, wherein the insertion portion comprises a chamber that receives air from the tone trough through an opening and projects sound away from the tone trough. The game call device may further include a bell that receives and envelopes the insertion portion of the mouthpiece. The bell may comprise a chamber that receives and guides sound from the bell. The projected sound may be projected from the mouthpiece chamber to the end of the bell and towards a prospective animal being hunted.

The mouthpiece may comprise a hard and rigid material. The material may comprise polycarbonate, acrylonitrile butadiene styrene (ABS), or other hard and rigid material.

The lip cushion may comprise a material that is soft, flexible or depressible. The material may comprise silicone or PVC soft material.

The lip cushion may comprise a fastener that connects and securely affixes the lip cushion to the mouthpiece. The lip cushion may comprise a base that has a surface that contacts a user's teeth. The fastener may comprise a wedge that engages a lip cushion receiver in the mouthpiece to secure the lip cushion to the mouthpiece.

The reed may comprise Mylar.

According to an embodiment of the disclosure, a game call device is disclosed having a mouthpiece, the game call device comprising a tone trough that carries and guides air moving through the game call device, a reed aligned with and positioned proximate the tone trough, and a lip cushion that securely attaches to the bottom of the mouthpiece on the game call device. The lip cushion may be positioned to contact a user's teeth during operation of the game call device. The tone trough and reed may be positioned such that air escaping from the tone trough causes the reed to vibrate and make variable sounds according to the location of a user's lip on the reed.

According to an embodiment of the disclosure, a game call device is disclosed having a mouthpiece and a bell, the game call device comprising a tone trough that carries and guides air moving through the mouthpiece, a reed aligned with and positioned proximate the tone trough, a lip cushion that securely attaches to the bottom of the mouthpiece, wherein the lip cushion includes a base having a surface that contacts a user's teeth. The base of the lip cushion may comprise a material that is soft, flexible or depressible. The lip cushion may comprise a fastener to securely attach the lip cushion to the mouthpiece.

Additional features, advantages, and embodiments of the disclosure may be set forth or apparent from consideration of the following detailed description and drawings. Moreover, it is noted that both the foregoing summary of the disclosure and the following detailed description are exemplary and intended to provide further explanation without limiting the scope of the disclosure.

### BRIEF DESCRIPTION OF THE DRAWINGS

The accompanying drawings, which are included to provide a further understanding of the disclosure, are incorporated in and constitute a part of this specification, illustrate embodiments of the disclosure and together with the detailed description serve to explain the principles of the disclosure. No attempt is made to show structural details of the disclosure in more detail than may be necessary for a fundamental understanding of the disclosure and the various ways in which it may be practiced.

FIG. 1 shows a front-perspective view of an example of a game call device that is constructed according to the principles of the disclosure.

FIG. 2 shows a top view of the game call device in FIG. 1.

FIG. 3 shows a bottom view of the game call device in FIG. 1.

FIG. 4 shows a side view of the game call device in FIG. 1.

FIG. 5 shows a front (mouthpiece end) view of the game call device in FIG. 1.

FIG. 6 shows a rear view of the game call device in FIG. 1.

FIG. 7 shows an exploded view of the game call device in FIG. 1.

FIG. 8 shows a top view of the game call device in FIG. 1, with a portion of the top of the game call device cut away.

FIG. 9 shows a side view of the game call device in FIG. 1, with a portion of the side of the game call device cut away.

FIG. 10 shows a side cut view of the game call device in FIG. 1, with half of the game call device cut away lengthwise.

FIG. 11 shows an example of a reed that is constructed according to the principles of the disclosure.

FIG. 12 shows an example of a reed lock that is constructed according to the principles of the disclosure.

FIG. 13 shows an example of a lip cushion that is constructed according to the principles of the disclosure.

FIG. 14 shows an example of a method for assembling the game call device in FIG. 1.

The present disclosure is further described in the detailed description and drawings that follows.

### DETAILED DESCRIPTION OF THE DISCLOSURE

The embodiments of the disclosure and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the disclosure. The examples used herein are intended merely to facilitate an understanding of ways in which the disclosure may be practiced and to further enable those of skill in the art to practice the embodiments of the disclosure. Accordingly, the examples and embodiments herein should not be construed as limiting the scope of the disclosure, which is defined solely by the appended claims and applicable law. Moreover, it is noted that like reference numerals represent similar parts throughout the several views of the drawings.

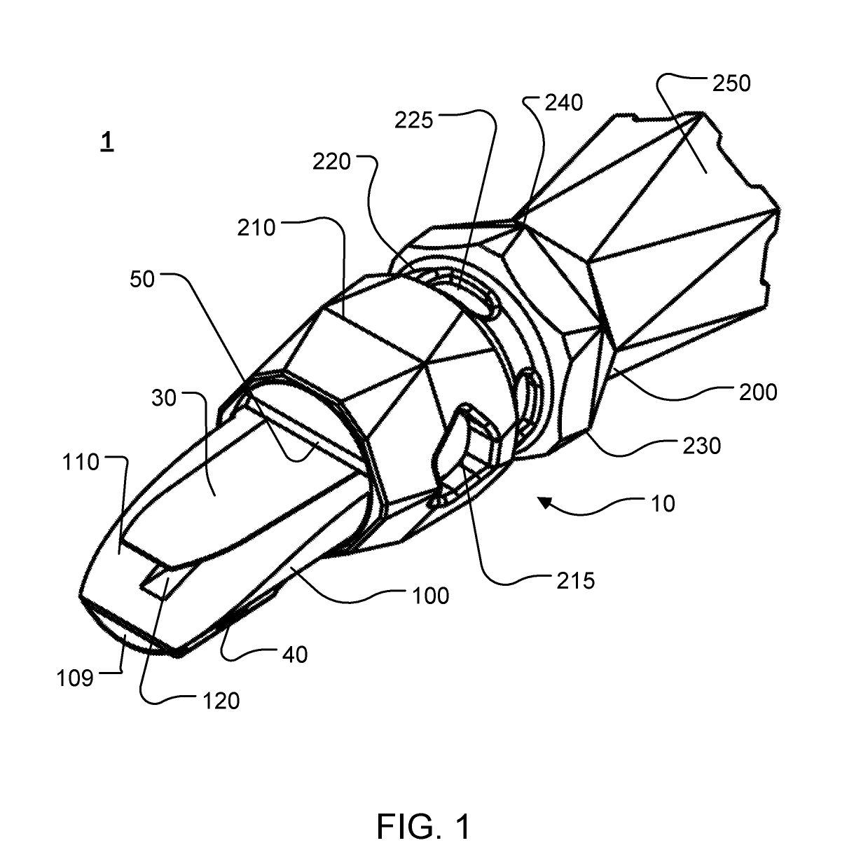

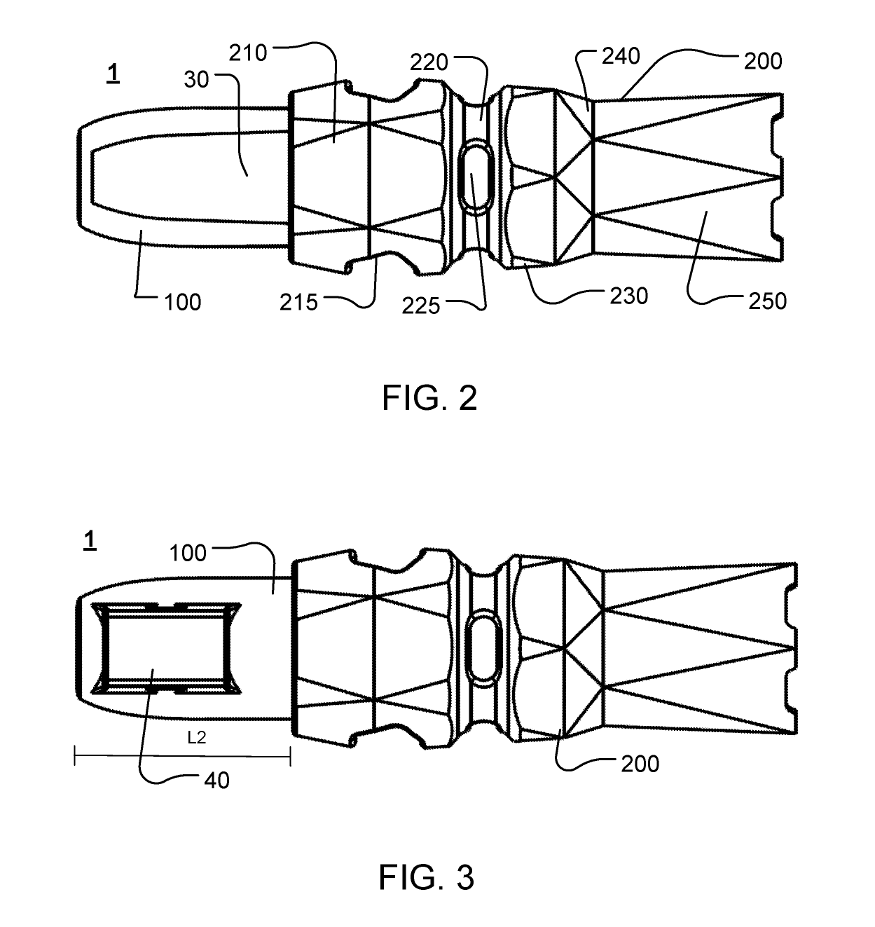

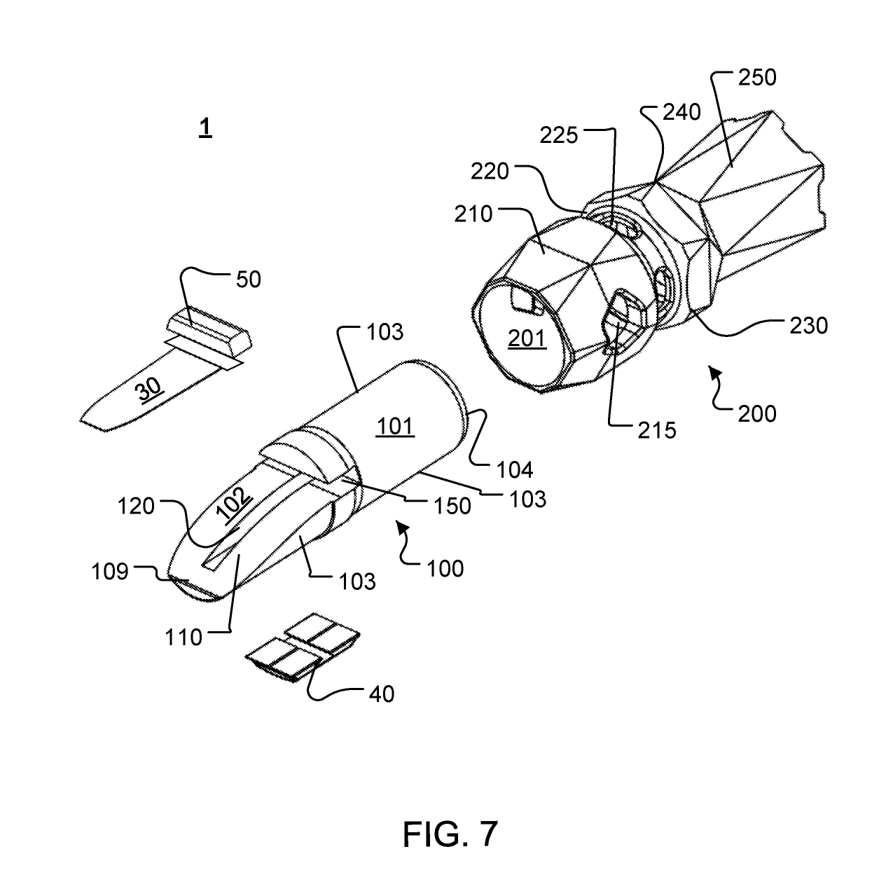

FIG. 1 shows a front-perspective view of an example of a game call device 1 that is constructed according to the principles of the disclosure. FIGS. 2-4 show top, bottom, and side views, respectively, of the call device 1. FIGS. 5 and 6 show front (mouthpiece) and rear views, respectively, of the call device 1. FIG. 7 shows an exploded view of the game call device 1.

Referring to FIGS. 1-7, the game call device 1 includes a housing 10, a reed 30, a lip cushion 40, and a reed lock 50. The housing 10 includes a mouthpiece 100 and a bell 200. The housing 10 may be made as a single piece (not shown) or two separate pieces that include the mouthpiece 100 and the bell 200 (e.g., shown in FIG. 7). In the latter embodiment, the mouthpiece may include an insertion portion 101 (shown in FIG. 7) that may be inserted or formed in a mouthpiece receiver 201 of the bell 200, as seen in FIG. 7. Alternatively, the receiver 201 may be slid over, or formed on and about so as to envelope the insertion portion 101 within the receiver 201.

The insertion portion 101 of the mouthpiece 100 may be substantially cylindrical in shape, as seen in FIG. 7, and integrally formed as a single piece with the non-insertion portion 102. Alternatively, insertion portion 101 and non-insertion portion 102 may be made from two or more separate pieces (not shown) and assembled to form the mouthpiece 100. During manufacturing, the mouthpiece 100 may be formed as a single piece. Alternatively, the insertion portion 101 and non-insertion portion 102 may be made by machining, for example, a block (e.g., a cylindrical, rectangular, or the like block, not shown) to remove material to form the insertion portion 101 and non-insertion portion 102 as understood by those skilled in the art, including the tapered (or angled or sloped) surface 110, tone trough 120, opening 122, reed lock receiver 150, and chamber 107.

The bell 200, including bell housing portions 210, 220, 230, 240, and 250, mouthpiece receiver 201, and the chamber 202 may be formed by, for example, an injection molding process, or any other suitable manufacturing process as understood by those skilled in the art. The bell 200 may be configured to be easily and securely gripped by the user's hand. The openings in 215 and 225 in the bell housing portions 210 and 220, respectively, may be formed during the injection molding process, or later opened using, for example, a drill bit (not shown). The housing portions 210-250 may have the shapes and designs seen in FIGS. 1-7, or any other shape or design without departing from the scope or spirit of the disclosure. For instance, the bell 200, including housing portions 210-250 (and/or mouthpiece 100), may have a shape, texture, color, scent, and/or design that facilitates concealment of the game call device 1 based on the intended environment of use. For example, the bell 200 (and/or mouthpiece 100) may be camouflaged or designed to resemble an article (e.g., a tree branch) in the intended environment of use.

The mouthpiece 100 and bell 200 may be made of the same material, or different materials. For example, the mouthpiece 100 may include a material such as, for example, metal, wood, ceramic, glass, plastic (e.g., polycarbonate), or the like. The material may be hard and resistant to environmental changes, such as, changes in temperature, humidity, sunlight, and the like.

The bell 200 may be made of the same material as the mouthpiece 100. Alternatively, the bell 200 may be made of a different material such as, for example, a material that provides for better bell by a user's hand or fingers. The material in the bell 200 may include, for example, thermoplastic elastomers (e.g., TPE), rubber, foam, silicone, PVC, or the like.

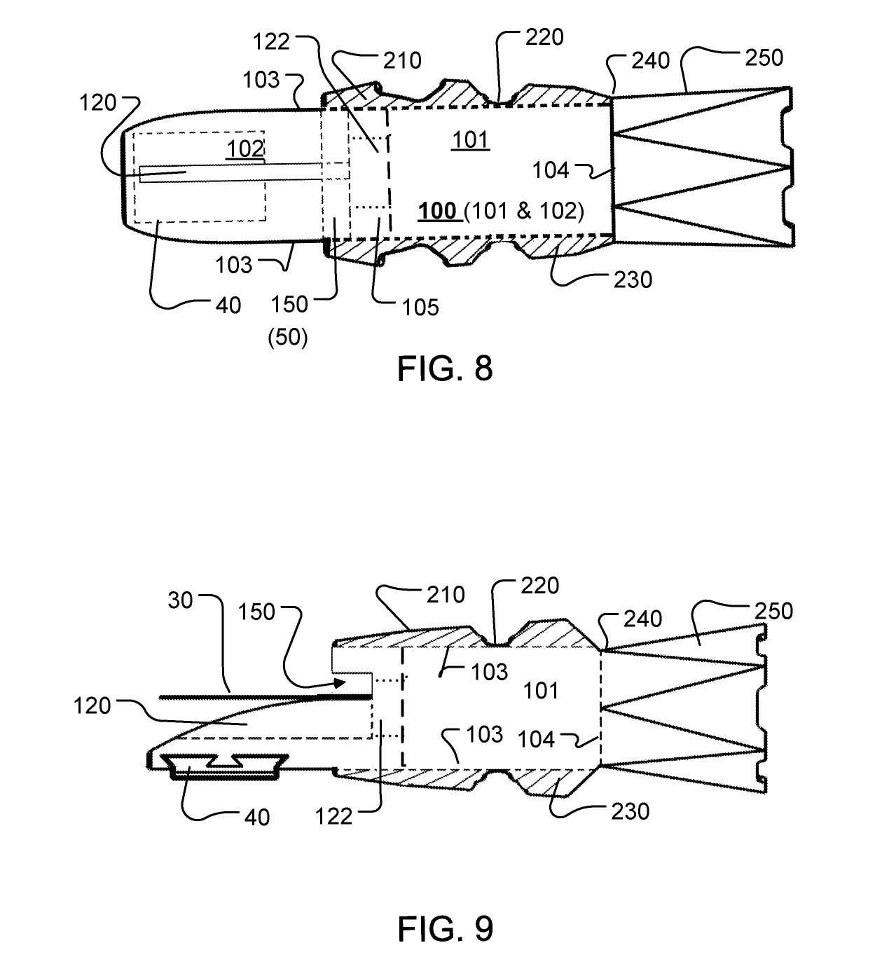

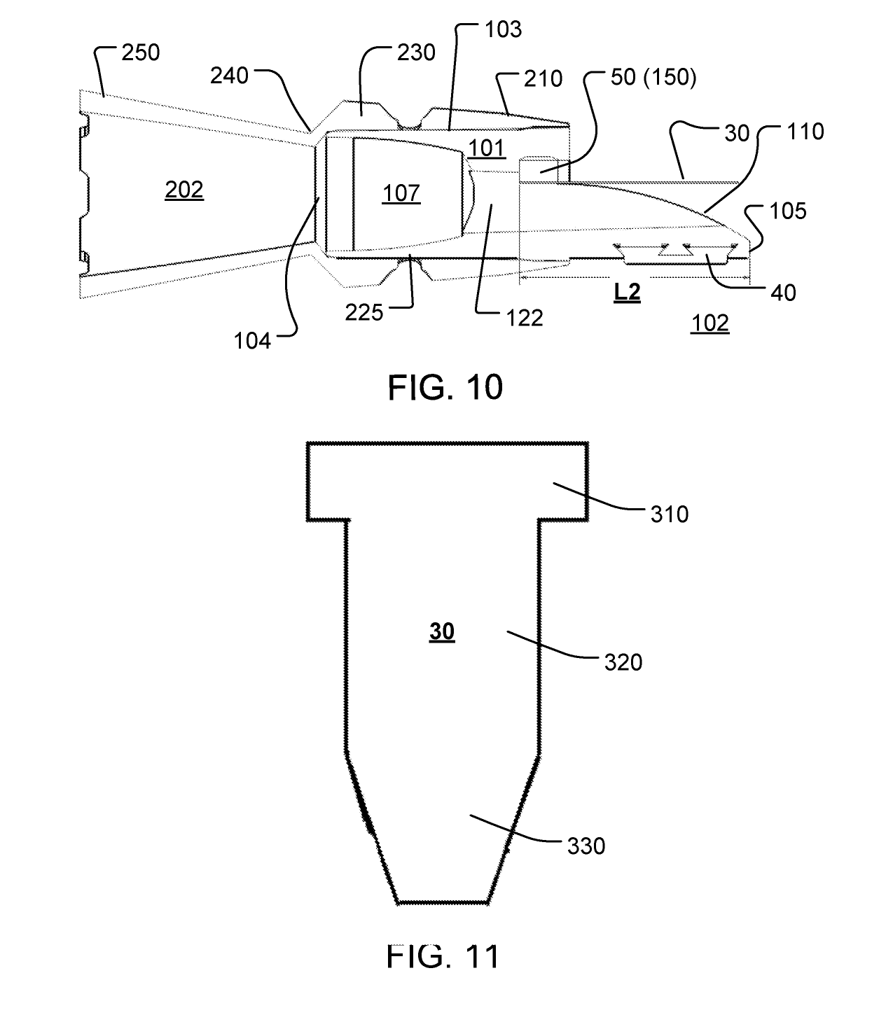

FIGS. 8 and 9 show top and side views, respectively, of the game call device 1 with a portion of the top and side of the game call device 1 cut away, respectively. FIG. 10 shows a lengthwise side cut view of the game call device 1 with half of the game call device cut away.

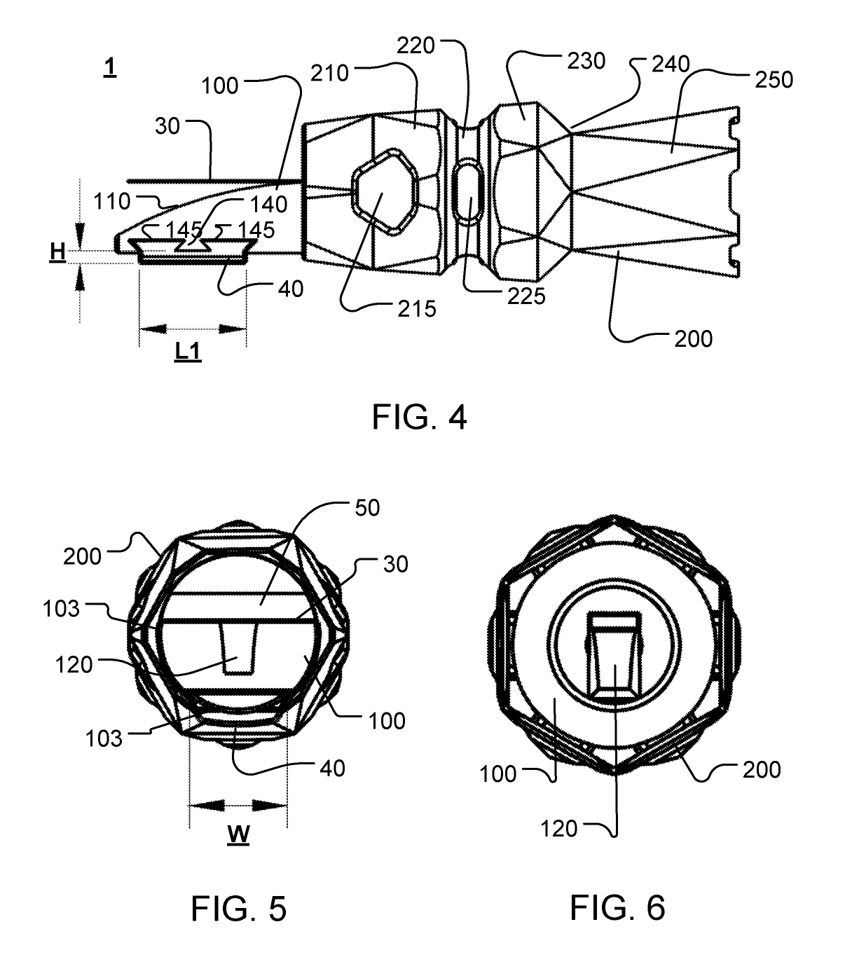

Referring to FIGS. 1-10, the portion 102 of the mouthpiece 100 may include an outer upper surface 110 (shown in FIGS. 1 and 4), outer side walls 103 (shown in FIGS. 7-10), and an annular end 104 (shown in FIGS. 7-10). The upper surface 110 may be tapered, sloped or angled, as seen in FIGS. 1 and 4. The outer side walls 103 may be semi-cylindrical, as seen in FIGS. 5, 7, 9 and 10. The outer side walls 103 of the insertion portion 101 of the mouthpiece 100 may be completely cylindrical, as seen in FIGS. 5 and 7-10.

The mouthpiece 100 includes the tone trough (or air channel) 120, which may be formed longitudinally along a length of the mouthpiece 100. The tone trough (or tone trough) 120 may extend from the non-insertion portion 102 to a part of the insertion portion 101, as seen in FIGS. 7-10. The tone trough 120 may have any shape suitable for directing air flow to facilitate projecting a desired game sound, including a rectangular shape (not shown), a square shape (not shown), a circular or semi-circular shape (not shown), a trapezoidal shape (shown in FIGS. 5 and 6), or any other suitable shape. The shape may vary along the length of the tone trough 120. For instance, the shape may be substantially rectangular at the distal end that is to be inserted in the user's mouth, and taper to a substantially trapezoidal shape as it approaches an inner region 105 in the insertion portion 101, and finally transition into an opening 122 in the inner region 105.

The opening 122 may have an elliptical shape formed in the inner region 105, which may be a solid wall (except for the opening 122) that is integrally formed with the mouthpiece 100. The width of the opening 122 in the inner region 105 may be wider than the width of the tone trough 120 in the area of the reed lock receiver 150, as seen in FIG. 8. The height of the opening 122 in the inner region 105 may be greater than the height of the tone trough 120, as seen in FIGS. 9 and 10. The floor of the tone trough 122 may be substantially parallel with the outer walls 103 (shown in FIG. 9), or sloped downward (shown in FIG. 10). Alternatively, the tone trough 122 floor may be sloped upward (not shown), or have a varying slope or design (not shown).

The tone trough 120 is configured to direct air flow in the tone trough through the opening 122 and through the chamber 107 (shown in FIG. 10). The inner walls of the chamber 107 may be tapered and/or curved outward so as direct sound outward in a predetermined direction. The tone trough 120 may be designed based on the desired sound to be produced by the game call device 1.

The reed 30 is aligned with, and positioned proximate the tone trough 120, as seen in FIGS. 1, 4, 9 and 10. The reed 30 has a width greater than the width of the tone trough 120. The reed 30 has a length that is substantially equal to or longer than the length of the tone trough 120. Preferably, the distal end of the reed 30 that is to be placed in the user's mouth (proximate the distal end 109 of the mouthpiece 100) extends beyond the distal end of the tone trough 120, such that when the distal end of the reed 30 is pressed toward and into contact with the surface 110, the reed 30 substantially covers the entire tone trough 120. When the reed 30 substantially covers the entire tone trough 120, the design may be configured so as to provide, for example, a substantially air-tight seal, thereby preventing or minimizing any air from entering and/or flowing in the tone trough 120.

FIG. 7 shows an example of the reed 30 that is constructed according to the principles of the disclosure. As seen, the reed 30 may have a tongue-like shape, having a substantially rectangular configuration at the distal end that is inserted into the reed receiver 150, and a semi-trapezoidal shape at the opposite distal end, with the sides edges tapering inward.

The reed 30 may be shaped and sized based on the desired sound to be produced by the game call device 1.

FIG. 11 shows an alternative example of the reed 30 that is constructed according to the principles of the disclosure. As seen in FIG. 11, the reed 30 may have a T-shape, which includes a fastener portion 310 that may be shaped and sized to match the shape and size of the reed receiver 150, so as to be firmly and securely held in the reed receiver 150 by the reed lock 50. The reed 30 of this embodiment further includes a mid-portion 320 and an end portion 330. As seen, the mid-portion 320 and the end portion 330 may have a tongue-like shape, having a substantially rectangular configuration proximate the fastener portion 310, and a semi-trapezoidal shape at the end portion 330, with the side edges tapering inward.

The reed 30 may include a material such as, for example, biaxially-oriented polyethylene terephthalate (BoPET), Mylar, Melinex, metal, or the like.

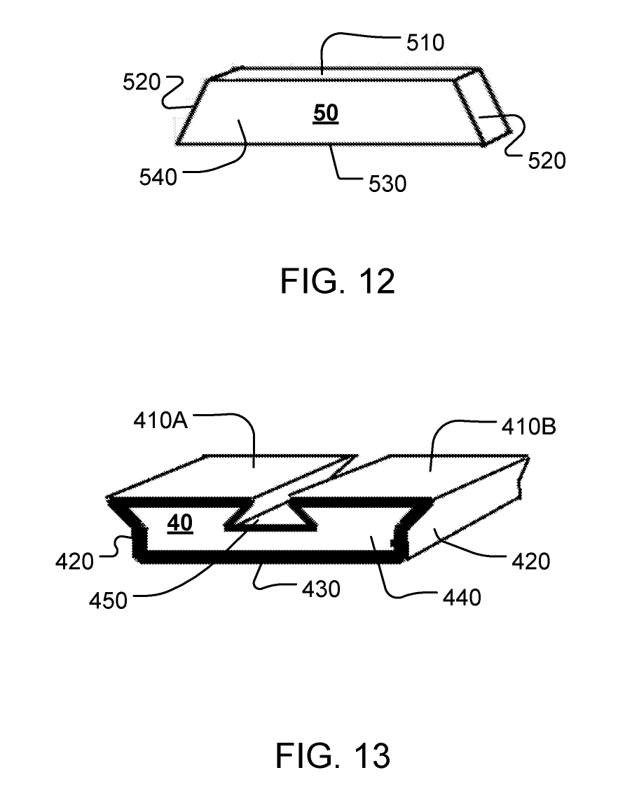

FIG. 12 shows an example of a reed lock 50 that is constructed according to the principles of the disclosure. As seen in FIGS. 7 and 12, the reed lock 50 may be a block that has a substantially trapezoidal shape, with side walls 520 that may be contoured to match the outer walls 103 of the mouthpiece 103, so as provide a substantially flush fit with the outer walls 103 when the reed lock 50 is placed in the reed receiver 150 (e.g., shown in FIG. 5). The top wall 510, bottom wall 530, front wall 540, and/or back wall (not shown) may be formed to match corresponding surfaces in the reed lock receiver 150. For instance, in the case where the surfaces in the reed lock receiver 150 are substantially flat, the top wall 510, bottom wall 530, and/or back wall (not shown) may be substantially flat. The reed lock 50 may be made of the same material as the mouthpiece 100 and/or bell 200, or a different material.

FIG. 13 shows an example of a lip cushion 40. As seen in FIGS. 3-5 and 7-10, the lip cushion 40 may be attached to the portion 102 of the mouthpiece 100. Alternatively, the lip cushion 40 may be integrally formed with the portion 102 using, for example, a multi-shot (e.g., two-shot) injection molding process, so as form the portion 102 having two or more different materials, such as, a soft material (e.g., silicone) for the lip cushion 40 and a hard material (e.g., PVC) for the rest of the portion 102.

Referring to FIG. 13, the lip cushion 40 may have one or more fasteners 410A, 410B, a base 430, side walls 420, front wall 440, and a back wall (not shown). The fasteners 410A, 410B may be configured to form a guide channel 450 therebetween. The guide channel 450 may have a substantially trapezoid shape. Alternatively, the guide channel 450 may have a circular shape, a cylindrical shape, a spherical shape, a square shape, a rectangular shape, or any other shape that will allow a correspondingly-shaped structure on the mouthpiece 100 to engage and securely attach to the guide channel 450.

The surface of the base portion 430 is configured to be contacted and held by the user's lower (or upper) lip and/or teeth. The base 430 may be made of a soft material that prevents or minimizes lip fatigue, lip abrasion, or any other mal-effects to the user's lip during extended usage.

The fasteners 410A, 410B may be integrally formed with, or attached to the base 430. The fasteners 410A, 410B are configured to slide into and engage lip cushion receivers 145 (shown in FIG. 4) in the mouthpiece 100, so as to securely and fixedly attach the lip cushion 40 to the mouthpiece 100. As seen in FIG. 3-5, 7, 9, 10, or 13, the fasteners 410A, 410B may each have a wedge-shaped design that matches a wedge-shaped opening in the corresponding lip cushion receiver 145 in the mouthpiece 100. The fasteners 410A, 410B may have the same shape, or different shapes. The fasteners 410A, 410B may have a circular shape, a cylindrical shape, a spherical shape, a square shape, a rectangular shape, or any other shape that will allow the fasteners 410A, 410B to be securely attached to the mouthpiece 100. For instance, the fasteners 410A, 410B may be inserted into and positioned in corresponding lip cushion receivers 145.

Referring to FIGS. 4 and 5, the base 430 of the lip cushion 40 has a length L1, a width W and a height (or thickness) H. The length L1 may be between 0.50″ and 1.25″, and preferably between 0.70″ and 0.80″, and most preferably about 0.745″. The width W may be between 0.25″ and 0.80″, and preferably between 0.50″ and 0.56″, and most preferably about 0.533″. The height H may be between 0.05″ and 0.15″, and preferably between 0.08″ and 0.10″, and most preferably about 0.090″. The lip cushion 40 may be positioned anywhere along the length L2 of the portion 102, but preferably closer to the distal end of the portion 102 that goes into the user's mouth, as seen in FIG. 10, for example. The length L2 may be between 1.25″ and 2.25″, and preferably between 1.50″ and 1.75″, and most preferably about 1.66″. However, varying lengths of L2 may be used according to different lengths needed to achieve different sounds according to different animals being hunted and called to.

Referring to FIG. 7, the game call device 1 may be provided as, for example, five pieces, including the reed 30, the lip cushion 40, reed lock 50, mouthpiece 100, and bell 200.

Alternatively, the game call device may be provided as, for example, three (or fewer) pieces, including the reed 30, lip cushion 40, and housing 10.

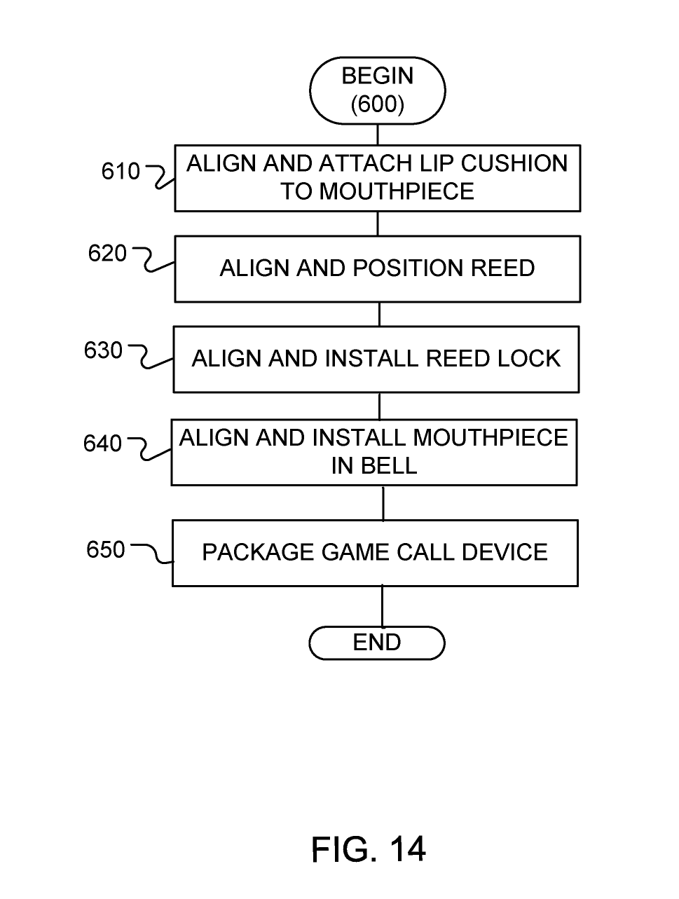

FIG. 14 shows a non-limiting example of a process 600 that may be implemented for assembling the game call device 1, seen in FIG. 7. Referring to FIGS. 7 and 14, the game call device 1 may be assembled by, for example, aligning the lip cushion 40 with lip cushion receiver 145 (shown in FIG. 4) and attaching the lip cushion 40 to the mouthpiece 100 by sliding the fasteners 410A, 410B into the corresponding lip cushion receiver 145 until the lip cushion is properly seated (Step 610).

The reed 30 may be installed by aligning the reed 30 longitudinally along, and over the tone trough 120, and positioning and centering the distal end of the reed 30 within reed receiver 150 (Step 620). After the reed 30 is properly positioned, the reed lock 50 may be aligned and inserted into the reed receiver 150 (Step 630), thereby securing the reed 30 in the mouthpiece 150. Alternatively, the reed 30 and reed lock 50 may be pre-aligned and simultaneously inserted into the reed receiver 150 (Steps 620 and 630 combined). The reed 30 and reed lock 50 may be formed as a single piece (not shown).

Alternatively, the reed receiver 150 may be sized so as to receive only the distal end portion of the reed 30 and securely hold the reed 30 in the mouthpiece 150, without the reed lock 50.

The insertion portion 101 may be aligned with and inserted into the mouthpiece receiver 201 of the bell 200 (Step 640). This step may be skipped where the mouthpiece 100 is formed integrally with the bell 200 as a single piece (not shown).

The assembled game call device 1 may be packaged and readied for shipment (Step 650).

Referring to FIGS. 1-10, as discussed above, the lip cushion 40 may be located on the bottom or under-side of the mouthpiece 100 and locked in place by a pair of tongue-and-groove-like structures 145/410. The reed 30 may be placed along the top length portion 102 of the mouthpiece 100, covering the tone trough 120 (e.g., a narrow longitudinal tone trough).

The user may implement the game call device 1 by placing his/her teeth against the lip cushion 40 while wrapping both top and bottom lips around the entire circumference of the portion 102 of the mouthpiece 100. Once the caller's lips have sealed completely around mouthpiece 100, the caller may begin to blow into the game call device 1. The caller may grasp the bell 200 to maintain control, with lower teeth lightly biting up (or down) on the lip cushion 40, so that the game call device 1 does not slip. The caller may begin to slide his/her upper lip along the length of the reed 30 to change tones to replicate animal sounds such as, for example, distress sounds of smaller animals, yips, barks and howls of coyotes of all ages, and/or mews, chirps or estrus cries of elk of all ages.

If a need occurs for caller's lower lip to slide along with the upper lip, the caller may simply reduce tension of teeth on the lip cushion 40 to allow both teeth and lower lip to slide accordingly along the lip cushion 40. With the majority of the holding power being accomplished using the lower (or upper) teeth against the lip cushion 40, the user does not have to use his/her lips and cheeks for this purpose and may, instead, use his/her lips and cheeks to seal off air flow around the mouthpiece 100 while maintaining a semi-tight cheek for variable air pressures to accomplish multiple volumes and pitches of desired sounds.

Referring to FIGS. 1 and 10, the air enters in and travels through the tone trough 120 (or tone trough) below the reed 30 when the caller blows into the mouthpiece 100. When air begins to escape though the tone trough 120, it causes the reed 30 to vibrate and make variable sounds according to the location of the user's upper (or lower) lip on the reed 30. Once the sound travels through the tone trough 120 and out through the opening 122, the sound will travel through the chamber 107 (and ultimately out the bell) to project and carry across long to short distances to reach the hearing of animals such as predators and/or elk.

The terms “including,” “comprising” and variations thereof, as used in this disclosure, mean “including, but not limited to,” unless expressly specified otherwise.

The terms “a,” “an,” and “the,” as used in this disclosure, means “one or more,” unless expressly specified otherwise.

Devices that are in communication with each other need not be in continuous communication with each other, unless expressly specified otherwise. In addition, devices that are in communication with each other may communicate directly or indirectly through one or more intermediaries.

Although process steps, method steps, or the like, may be described in a sequential order, such processes or methods may be configured to work in alternate orders. In other words, any sequence or order of steps that may be described does not necessarily indicate a requirement that the steps be performed in that order. The steps of the processes or methods described herein may be performed in any order practical. Further, some steps may be performed simultaneously.

When a single device or article is described herein, it will be readily apparent that more than one device or article may be used in place of a single device or article. Similarly, where more than one device or article is described herein, it will be readily apparent that a single device or article may be used in place of the more than one device or article. The functionality or the features of a device may be alternatively embodied by one or more other devices which are not explicitly described as having such functionality or features.

While the disclosure has been described in terms of exemplary embodiments, those skilled in the art will recognize that the disclosure can be practiced with modifications in the spirit and scope of the instant disclosure. These examples given above are merely illustrative and are not meant to be an exhaustive list of all possible designs, embodiments, applications or modifications of the disclosure.

What is claimed is:

1. A game call device, comprising:
a mouthpiece having a mouthpiece portion and an insertion portion, wherein the mouthpiece portion includes
a tone trough that carries and guides air moving through the mouthpiece,
a reed aligned with and positioned proximate the tone trough,
a reed lock that secures an end portion of the reed to the mouthpiece,
a lip cushion that securely attaches to the mouthpiece, and
wherein the insertion portion comprises a bell that receives sound from the tone trough through an opening and projects sound away from the tone trough; and
a bell that receives and envelopes the insertion portion of the mouthpiece,
wherein the bell comprise a chamber that receives and guides sound through the bell.

2. The game call device according to claim 1, wherein the mouthpiece comprises a hard and rigid material.

3. The game call device according to claim 1, wherein the lip cushion comprises a material that is soft, flexible or depressible.

4. The game call device according to claim 1, wherein the reed comprises Mylar.

5. The game call device according to claim 1, wherein the insertion portion of the mouthpiece comprises a substantially cylindrical wall.

6. The game call device according to claim 1, wherein the lip cushion comprises a substantially rectangular surface.

7. The game call device according to claim 1, wherein the lip cushion comprises a fastening portion.

8. The game call device according to claim 1, wherein the lip cushion comprises a base portion having a surface that contacts a user's teeth.

9. The game call device according to claim 7, wherein the fastening portion comprises a tongue and groove that engages a lip cushion receiver in the mouthpiece to secure the lip cushion to the mouthpiece.

10. A game call device having a housing, comprising:
a tone trough that carries and guides air moving through the game call device;
a reed aligned with and positioned proximate the tone trough; and
a lip cushion that securely attaches to the game call device,
wherein the lip cushion is positioned to contact a user's teeth during operation of the game call device.

11. The game call device according to claim 10, wherein the tone trough and reed are positioned such that air escaping from the tone trough causes the reed to vibrate and make variable sounds according to the location of a user's lip on the reed.

12. The game call device according to claim 10, wherein the housing comprises a hard and rigid material.

13. The game call device according to claim 10, wherein the lip cushion comprises a soft or depressible material.

14. The game call device according to claim 10, wherein the reed comprises Mylar.

15. The game call device according to claim 10, wherein the lip cushion comprises silicone.

16. A game call device having a mouthpiece and a bell, the game call device comprising:
a tone trough that carries and guides air moving through the mouthpiece;
a reed aligned with and positioned proximate the tone trough;
a lip cushion that securely attaches to a bottom of the mouthpiece,
wherein the lip cushion includes a base portion having a surface that contacts a user's teeth.

17. The game call device according to claim 16, wherein the base portion of the lip cushion comprises a material that is soft, flexible or depressible.

18. The game call device according to claim 16, wherein the reed comprises Mylar.

19. The game call device according to claim 16, wherein the base portion of the lip cushion comprises silicone.

20. The game call device according to claim 16, wherein the lip cushion further comprises a fastening portion that securely attaches the lip cushion to the mouthpiece.
